(19) United States
(12) Patent Application Publication
(10) Pub. No.: US 2016/0264488 A1
(43) Pub. Date: Sep. 15, 2016

(54) PLANT GROWTH VEHICLE FROM CO-PRODUCTS OF A LIGNOCELLULOSIC BIOMASS PROCESS

(71) Applicant: E I DU PONT DE NEMOURS AND COMPANY, Wilmington, DE (US)

(72) Inventors: PAUL JOSEPH FAGAN, WILMINGTON, DE (US); KAYLEIGH J FERGUSON, GREENVILLE, DE (US); KATRINA KRATZ, CHADDS FORD, PA (US)

(21) Appl. No.: 15/067,356

(22) Filed: Mar. 11, 2016

Related U.S. Application Data
(60) Provisional application No. 62/132,072, filed on Mar. 12, 2015.

(51) Int. Cl. C05G 3/00; C05G 3/04

(52) U.S. Cl. CPC C05G 3/0047; C05G 3/04

(57) ABSTRACT

Lignocellulosic filter cake and lignocellulosic syrup, together with at least one plant growth material, provide a growth vehicle composition used to stabilize and anchor plant material and to provide various types of nutrients and other additives that benefit plant growth. The lignocellulosic filter cake and lignocellulosic syrup are two of the co-products of a lignocellulosic biomass fermentation process.

### CROSS-REFERENCE TO RELATED APPLICATIONS

This application claims the benefit of priority to U.S. Provisional Patent Application No. 62/132,072 filed on Mar. 12, 2015, which is incorporated by reference in its entirety.

### FIELD

This disclosure relates to the field of providing plants with a growth vehicle using co-products derived from a lignocellulosic biomass process.

### BACKGROUND

A variety of ingredients are commonly used to provide nutrients in soil to improve plant growth and yield. The agricultural community is always looking for new materials and ingredients that can be used to improve growth media to cultivate plants. It is also desirable to improve delivery of nutrients to plants, which could lead to improving their yield, through preventing nutrient leaching.

Bio-refineries producing second generation biofuels, alcohols, and other products from lignocellulosic biomass, can provide opportunities to obtain new materials suitable to be used as growth media for a variety of plants.

### SUMMARY

In one aspect, the disclosure relates to a plant growth vehicle composition comprising:
a) lignocellulosic filter cake;
b) pretreated lignocellulosic syrup; and
c) a plant active material;
   wherein the composition supports plant growth.

In one aspect the lignocellulosic syrup of the composition is a pretreated syrup.

In another aspect, the disclosure relates to a method for providing a growth vehicle for plant material, comprising:
a) providing lignocellulosic filter cake;
b) providing lignocellulosic syrup;
c) contacting the lignocellulosic filter cake and the lignocellulosic syrup to form a plant growth vehicle;
d) providing the plant material; and
e) contacting the plant material with the growth vehicle of (c);
wherein the growth vehicle allows the plant material to grow.

In one aspect the lignocellulosic syrup of the method is a pretreated syrup.

### DETAILED DESCRIPTION

It is the object of the instant disclosure to provide a growth vehicle to provide means to stabilize and anchor plant roots and also to provide various types of nutrients that plants require for their growth. Further, the instant disclosure provides means to prevent leaching of plant nutrients into the environment. In the instant disclosure lignocellulosic filter cake and lignocellulosic syrup, which are two of the co-products of a lignocellulosic biomass fermentation process, are used.

### DEFINITIONS

The following definitions and abbreviations are to be used for the interpretation of the claims and the specification.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The indefinite articles “a” and “an” preceding an element or component of the disclosure are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As used herein, the term “about” modifying the quantity of an ingredient or reactant of the disclosure employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The term “fermentable sugar” refers to oligosaccharides and monosaccharides that can be used as a carbon source by a microorganism in a fermentation process.

The term “lignocellulosic” refers to a composition comprising both lignin and cellulose. Lignocellulosic material may also comprise hemicellulose.

The term “cellulosic” refers to a composition comprising cellulose and additional components, including hemicellulose.

The term “saccharification” refers to the production of fermentable sugars from polysaccharides.

The term “pretreated biomass” means biomass that has been subjected to pretreatment prior to saccharification. The pretreatment may take the form of physical, thermal or chemical means and combinations thereof.

The term “lignocellulosic biomass” refers to any lignocellulosic material and includes materials comprising cellulose, hemicellulose, lignin, starch, oligosaccharides and/or monosaccharides. Biomass can also comprise additional components, such as protein and/or lipid. Biomass can be derived from a single source, or biomass can comprise a mixture derived from more than one source; for example, biomass could comprise a mixture of corn cobs and corn stover, or a mixture of grass and leaves. Lignocellulosic biomass includes, but is not limited to, bioenergy crops, agricultural residues, municipal solid waste, industrial solid waste, sludge from paper manufacture, yard waste, wood and forestry waste. Examples of biomass include, but are not limited to, corn cobs, crop residues such as corn husks, corn stover, grasses (including Miscanthus), wheat straw, barley straw, hay, rice straw, switchgrass, waste paper, sugar cane bagasse, sorghum material, soybean plant material, components obtained from milling of grains or from using grains in production processes (such as DDGS: dried distillers grains with solubles), trees, branches, roots, leaves, wood chips, sawdust, shrubs and bushes, vegetables, fruits, flowers, empty palm fruit bunch, and energy cane.

The term “energy cane” refers to sugar cane that is bred for use in energy production. It is selected for a higher percentage of fiber than sugar. The term “lignocellulosic biomass hydrolysate” refers to the product resulting from saccharification of lignocellulosic biomass. The biomass may also be pretreated or pre-processed prior to saccharification.

The term “lignocellulosic biomass hydrolysate fermentation broth” is broth containing product resulting from biocatalyst growth and production in a medium comprising lignocellulosic biomass hydrolysate. This broth includes components of lignocellulosic biomass hydrolysate that are not consumed by the biocatalyst, as well as the biocatalyst itself and product made by the biocatalyst.

The term “slurry” refers to a mixture of insoluble material and a liquid. A slurry may also contain a high level of dissolved solids. Examples of slurries include a saccharification broth, a fermentation broth, and a stillage.

The term “whole stillage” refers to the bottoms of a distillation. The whole stillage contains the high boilers and any solids of a distillation feed stream. Whole stillage is a type of depleted broth.

The term “thin stillage” refers to a liquid fraction resulting from solid/liquid separation of a whole stillage, fermentation broth, or product depleted fermentation broth.

The term “product depleted broth” or “depleted broth” refers herein to a lignocellulosic biomass hydrolysate fermentation broth after removal of a product stream.

The terms “lignocellulosic syrup” or “syrup” mean a concentrated product produced from the removal of water, generally by evaporation, from thin stillage.

The term “untreated lignocellulosic syrup”, as used herein, refers to syrup that has not been treated either enzymatically or chemically or both, to reduce or eliminate concentration of undesirable components such as acetamide in it.

The term “pretreated lignocellulosic syrup” refers to syrup that has gone through either a chemical or an enzymatic treatment or both to reduce or eliminate its undesirable components.

The term “soil substitute”, as used herein, refers to any material that can be used, in place of commonly used variety of soils, to provide support for the plant structure and provide the required nutrients for its growth under the desired conditions.

The term “target product” refers to any product that is produced by a microbial production host cell in a fermentation process. Target products may be the result of genetically engineered enzymatic pathways in host cells or may be produced by endogenous pathways. Typical target products include but are not limited to acids, alcohols, alkanes, alkenes, aromatics, aldehydes, ketones, biopolymers, proteins, peptides, amino acids, vitamins, antibiotics, and pharmaceuticals.

The term “fermentation” refers broadly to the use of a biocatalyst to produce a target product. Typically the biocatalyst grows in a fermentation broth utilizing a carbon source in the broth, and through its metabolism produces a target product.

“Solids” refers to soluble solids and insoluble solids. Solids from a lignocellulosic fermentation process contain residue from the lignocellulosic biomass used to make hydrolysate medium.

“Volatiles” refers herein to components that will largely be vaporized in a process where heat is introduced. Volatile content is measured herein by establishing the loss in weight resulting from heating under rigidly controlled conditions to 950° C. (as in ASTM D-3175). Typical volatiles include, but are not limited to, hydrogen, oxygen, nitrogen, acetic acid, and some carbon and sulfur.

“Fixed carbon” refers herein to a calculated percentage made by summing the percent of moisture, percent of ash, and percent of volatile matter, and then subtracting that percent from 100.

“Ash” is the weight of the residue remaining after burning under controlled conditions according to ASTM D-3174.

“Sugars” as referred to in the lignocellulosic syrup composition means a total of monosaccharide and soluble oligosaccharides.

As used herein, “macronutrients” are any nitrogen (N), phosphorus (P), or potassium (K) containing substance which can deliver nutrition to the plant.

As used herein, “micronutrients” are substances that are required in small amounts for plant growth such as boron (B), calcium (Ca) chlorine (CI), manganese (Mn), iron (Fe), zinc (Zn), copper (Cu), molybdenum (Mo) and selenium (Se). Hereafter, the term “nutrients” is used for both macro- and micro-nutrients. As defined herein, “plant” or “plant material” is intended to refer to any part of a plant (e.g., roots, foliage, shoot) as well as seeds, trees, shrubbery, flowers, and grasses.

As used herein, the term “growth vehicle” refers to various combinations of lignocellulosic filter cake and lignocellulosic syrup, with optional additional materials, that can be used to support growth of various plant materials.

As used herein, the term “contacting” refers to mixing, blending, pouring, or dumping together filter cake and lignocellulosic syrup.

As used herein, the term “plant growth”, refers to any increase of plant biomass comprising at least one of: germination of seeds, emerging of leaves on existing stems, increasing the height of the stem, increasing the width of the stem, increasing the root mass, flowering and fruit/seed production.

### Fermentation of Lignocellulosic Biomass

The lignocellulosic filter cake (hereafter “FC”) suitable for application in the instant disclosure is produced as a co-product from a process that uses lignocellulosic biomass as a source of fermentable sugars which are used as a carbon source for a biocatalyst. The biocatalyst uses the sugars in a fermentation process to produce a target product.

To produce fermentable sugars from lignocellulosic biomass, the biomass is treated to release sugars such as glucose, xylose, and arabinose from the polysaccharides of the biomass. Lignocellulosic biomass may be treated by any method known by one skilled in the art to produce fermentable sugars in a hydrolysate. Typically the biomass is pretreated using physical, thermal and/or chemical treatments, and saccharified enzymatically. Thermo-chemical pretreatment methods include steam explosion or methods of swelling the biomass to release sugars (see for example WO2010113129; WO2010113130). Chemical saccharification may also be used. Physical treatments such as these may be used for particle size reduction prior to further chemical treatment. Chemical treatments include base treatment such as with strong base (ammonia or NaOH), or acid treatment (U.S. Pat. No. 8,545,633; WO2012103220). In one embodiment the biomass is treated with ammonia (U.S. Pat. No. 7,932,063; U.S. Pat. No. 7,781,191; U.S. Pat. No. 7,998,713; U.S. Pat. No. 7,915,017). These treatments release polymeric sugars from the biomass. In one embodiment the pretreatment is a low ammonia pretreatment where biomass is contacted with an aqueous solution comprising ammonia to form a biomass-aqueous ammonia mixture where the ammonia concentration is sufficient to maintain alkaline pH of the biomass-aqueous ammonia mixture but is less than about 12 weight percent relative to dry weight of biomass, and where dry weight of biomass is at least about 15 weight percent solids relative to the weight of the biomass-aqueous ammonia mixture, as disclosed in U.S. Pat. No. 7,932,063, which is herein incorporated by reference.

Saccharification, which converts polymeric sugars to monomeric sugars, may be either by enzymatic or chemical treatments. The pretreated biomass is contacted with a saccharification enzyme consortium under suitable conditions to produce fermentable sugars. Prior to saccharification, the pretreated biomass can be brought to the desired moisture content and treated to alter the pH, composition or temperature such that the enzymes of the saccharification enzyme consortium will be active. The pH can be altered through the addition of acids in solid or liquid form. Alternatively, carbon dioxide (CO₂), which can be recovered from fermentation, can be utilized to lower the pH. For example, CO₂ can be collected from a fermenter and fed into the pretreatment product headspace in the flash tank or bubbled through the pretreated biomass if adequate liquid is present while monitoring the pH, until the desired pH is achieved. The temperature is brought to a value that is compatible with saccharification enzyme activity, as noted below. Typically suitable conditions can include temperature from about 40° C. to about 50° C. and pH between from about 4.8 to about 5.8.

Enzymatic saccharification of cellulosic or lignocellulosic biomass typically makes use of an enzyme composition or blend to break down cellulose and/or hemicellulose and to produce a hydrolysate containing sugars such as, for example, glucose, xylose, and arabinose. Saccharification enzymes are reviewed in Lynd, L. R., et al. (Microbiol. Mol. Biol. Rev., 66:506-577, 2002). At least one enzyme is used, and typically a saccharification enzyme blend is used that includes one or more glycosidases. Glycosidases hydrolyze the ether linkages of di-, oligo-, and polysaccharides and are found in the enzyme classification EC 3.2.1.x (Enzyme Nomenclature 1992, Academic Press, San Diego, Calif. with Supplement 1 (1993), Supplement 2 (1994), Supplement 3 (1995, Supplement 4 (1997) and Supplement 5 [in Eur. J. Biochem., 223:1-5, 1994; Eur. J. Biochem., 232:1-6, 1995; Eur. J. Biochem., 237:1-5, 1996; Eur. J. Biochem., 250:1-6, 1997; and Eur. J. Biochem., 264:610-650 1999, respectively]) of the general group “hydrolases” (EC 3.). Glycosidases useful in saccharification can be categorized by the biomass components they hydrolyze. Glycosidases useful in saccharification can include cellulose-hydrolyzing glycosidases (for example, cellulases, endoglucanases, exoglucanases, cellobiohydrolases, β-glucosidases), hemicellulose-hydrolyzing glycosidases (for example, xylanases, endoxylanases, exoxylanases, β-xylosidases, arabino-xylanases, mannases, galactases, pectinases, glucuronidases), and starch-hydrolyzing glycosidases (for example, amylases, α-amylases, β-amylases, glucoamylases, α-glucosidases, isoamylases). In addition, it can be useful to add other activities to the saccharification enzyme consortium such as peptidases (EC 3.4.x.y), lipases (EC 3.1.1.x and 3.1.4.x), ligninases (EC 1.11.1.x), or feruloyl esterases (EC 3.1.1.73) to promote the release of polysaccharides from other components of the biomass. It is known in the art that microorganisms that produce polysaccharide-hydrolyzing enzymes often exhibit an activity, such as a capacity to degrade cellulose, which is catalyzed by several enzymes or a group of enzymes having different substrate specificities. Thus, a “cellulase” from a microorganism can comprise a group of enzymes, one or more or all of which can contribute to the cellulose-degrading activity. Commercial or non-commercial enzyme preparations, such as cellulase, can comprise numerous enzymes depending on the purification scheme utilized to obtain the enzyme. Many glycosyl hydrolase enzymes and compositions thereof that are useful for saccharification are disclosed in WO 2011/038019 or WO2012/125937, both incorporated by reference. Additional enzymes for saccharification include, for example, glycosyl hydrolases that hydrolyze the glycosidic bond between two or more carbohydrates, or between a carbohydrate and a noncarbohydrate moiety.

Saccharification enzymes can be obtained commercially. Such enzymes include, for example, Spezyme® CP cellulase, Multifect® xylanase, Accelerase® 1500, Accellerase® DUET, and Accellerase® Trio™ (Dupont™/Genencor®, Wilmington, Del.), and Novozyme-188 (Novozymes, 2880 Bagsvaerd, Denmark). In addition, saccharification enzymes can be provided as crude preparations of a cell extract or a whole cell broth. The enzymes can be produced using recombinant microorganisms that have been engineered to express one or more saccharifying enzymes. For example, an H3A protein preparation that can be used for saccharification of pretreated lignocellulosic biomass is a crude preparation of enzymes produced by a genetically engineered strain of Trichoderma reesei, which includes a combination of cellulases and hemicellulases and is described in WO 2011/038019, which is incorporated herein by reference.

Chemical saccharification treatments can be used and are known to one skilled in the art, such as treatment with mineral acids including HCl and H₂SO₄ (U.S. Pat. No. 5,580,389, WO2011002660).

Sugars such as glucose, xylose and arabinose are released by saccharification of lignocellulosic biomass and these monomeric sugars provide a carbohydrate source for a biocatalyst used in a fermentation process. The sugars are present in a biomass hydrolysate that is used as fermentation medium. The fermentation medium can be composed solely of hydrolysate, or can include components additional to the hydrolysate such as sorbitol or mannitol at a final concentration of about 5 mM as described in U.S. Pat. No. 7,629,156, which is incorporated herein by reference. The biomass hydrolysate typically makes up at least about 50% of the fermentation medium. Typically about 10% of the final volume of fermentation broth is seed inoculum containing the biocatalyst.

The medium comprising hydrolysate is fermented in a fermenter, which is any vessel that holds the hydrolysate fermentation medium and at least one biocatalyst, and has valves, vents, and/or ports used in managing the fermentation process.

Any biocatalyst that produces a target product utilizing glucose and preferably also xylose, either naturally or through genetic engineering, may be used for fermentation of the fermentable sugars in the biomass hydrolysate made from lignocellulosic biomass. Target products that may be produced by fermentation include, for example, acids, alcohols, alkanes, alkenes, aromatics, aldehydes, ketones, biopolymers, proteins, peptides, amino acids, vitamins, antibiotics, and pharmaceuticals. Alcohols include, but are not limited to methanol, ethanol, propanol, isopropanol, butanol, ethylene glycol, propanediol, butanediol, glycerol, erythritol, xylitol, mannitol, and sorbitol. Acids may include acetic acid, formic acid, lactic acid, propionic acid, 3-hydroxypropionic acid, butyric acid, gluconic acid, itaconic acid, citric acid, succinic acid, 3-hydroxyproprionic acid, fumaric acid, maleic acid, and levulinic acid. Amino acids may include glutamic acid, aspartic acid, methionine, lysine, glycine, arginine, threonine, phenylalanine and tyrosine. Additional target products include methane, ethylene, acetone and industrial enzymes.

The fermentation of sugars in biomass hydrolysate to target products can be carried out by one or more appropriate biocatalysts, that are able to grow in medium containing biomass hydrolysate, in single or multistep fermentations. Biocatalysts may be microorganisms selected from bacteria, filamentous fungi and yeast. Biocatalysts can be wild type microorganisms or recombinant microorganisms, and can include, for example, organisms belonging to the genera of Escherichia, Zymomonas, Saccharomyces, Candida, Pichia, Streptomyces, Bacillus, Lactobacillus, and Clostridiuma. Typical examples of biocatalysts include recombinant Escherichia coli, Zymomonas mobilis, Bacillus stearothermophilus, Saccharomyces cerevisiae, Clostridia thermocellum, Thermoanaerobacterium saccharolyticum, and Pichia stipitis. To grow well and have high product production in a lignocellulosic biomass hydrolysate fermentation broth, a biocatalyst can be selected or engineered to have higher tolerance to inhibitors present in biomass hydrolysate such as acetate. For example, the biocatalyst may produce ethanol as a target product, such as production of ethanol by Zymomonas mobilis as described in U.S. Pat. No. 8,247,208, which is incorporated herein by reference.

Fermentation is carried out with conditions appropriate for the particular biocatalyst used. Adjustments can be made for conditions such as pH, temperature, oxygen content, and mixing. Conditions for fermentation of yeast and bacterial biocatalysts are well known in the art.

In addition, saccharification and fermentation may occur at the same time in the same vessel, called simultaneous saccharification and fermentation (SSF). In addition, partial saccharification may occur prior to a period of concurrent saccharification and fermentation in a process called HSF (hybrid saccharification and fermentation).

For large scale fermentations, typically a smaller culture (seed culture) of the biocatalyst is first grown. The seed culture is added to the fermentation medium as an inoculum typically in the range from about 2% to about 20% of the final volume.

Typically fermentation by the biocatalyst produces a fermentation broth containing the target product made by the biocatalyst. For example, in an ethanol process the fermentation broth may be a beer containing from about 6% to about 10% ethanol. In addition to target product, the fermentation broth contains water, solutes, and solids from the hydrolysate medium and from biocatalyst metabolism of sugars in the hydrolysate medium. Typically the target product is isolated from the fermentation broth producing a depleted broth, which can be called whole stillage. For example, when ethanol is the product, the broth is distilled, typically using a beer column, to generate an ethanol product stream and a whole stillage. Distillation can be using any conditions known to one skilled in the art including at atmospheric or reduced pressure. The distilled ethanol is further passed through a rectification column and molecular sieve to recover an ethanol product. The target product may alternatively be removed in a later step such as from a solid or liquid fraction after separation of fermentation broth.

### Filter Cake Production

Filter cake (FC) is produced as a co-product from a lignocellulosic biomass fermentation process. Typically filter cake is made from whole stillage that remains after distillation of a volatile target product that can be separated from fermentation broth by distillation. In one embodiment, filter cake is produced during fermentation of a lignocellulosic biomass hydrolysate to produce an alcohol such as ethanol. During production of ethanol from lignocellulosic biomass, fermentation broth is distilled to recover ethanol. The fermentation broth is processed in a distillation column to separate the ethanol and some water from the solids and the bulk of the water. Ethanol goes overhead and the solids and water exit the bottom of the column and are called “whole stillage”. The high lignin-content solids in the whole stillage are separated from the liquid typically using a filter press. These solids are called filter cake (hereafter FC) and are then removed from the system. The liquid fraction is further processed by evaporation using a multi-effect, falling film evaporator system and the evaporated water is condensed and treated by anaerobic digestion. Removing the water from the liquid fraction produces high-solids, lignocellulosic syrup (hereafter “untreated syrup”).

### Filter Cake Composition

The filter cake can be used wet, or it can be dried which is typically by air drying. The wet lignocellulosic filter cake composition contains from about 35% to 65% moisture (can have about 35%, 40%, 45%, 50%, 55%, 60%, or 65% moisture), from about 20% to about 75% volatiles (can have about 20%, 25%, 30%, 35%, 40%, 45%, 50%, 55%, 60%, 65%, or 75% volatiles), from about 35% to 65% solids (can have about 35%, 40%, 45%, 50%, 55%, 60%, or 65% solids), from about 1% to about 30% ash (can have about 1%, 3%, 5%, 10%, 15%, 20%, 25%, or 30% ash), from about 5% to about 20% fixed carbon, and it has an energy value of about 2,000 to about 9,000 BTU/lb (can have about 2,000, 2,500, 3,000, 3,500, 4,000, 4,500, 5,000, 5,500, 6,000, 6,500, 7,000, 7,500, 8,000, 8,500, or 9,000 BTU/lb). The volatile content is measured by establishing the loss in weight resulting from heating under rigidly controlled conditions to 950° C. (as in ASTM D-3175). Typical volatiles include hydrogen, oxygen, nitrogen, acetic acid, and some carbon and sulfur. Ash is determined by weighing the residue remaining after burning under controlled conditions according to ASTM D-3174. The amount of fixed carbon is calculated by adding the percentages of moisture, ash, and volatiles, and then subtracting from 100. The full upper range of BTU/lb is typically achieved with drying. FC can be dried and/or processed, such as using a hammermill, into particles prior to application.

For the practice of the instant disclosure, the FC obtained from fermentation of lignocellulosic biomass can be used as is or it can be dried to reduce its moisture content from between about 40 wt % and about 60 wt %, to between about 0 and about 50 wt % based on the total weight of the filter cake. Alternatively, the moisture content of the FC can be from about 0 to about 40 wt % based on the total weight of the filter cake. Further, the moisture content of the FC can be from about 0 to about 20 wt % based on the total weight of the filter cake. In an embodiment of the instant disclosure the moisture content of the FC is about 5%.

Reducing the amount of moisture in the FC can be achieved using methods well known to those experienced in the relevant art such as conventional ovens, microwave ovens, air dryers, etc. Alternatively, the FC can be left at ambient temperature (from about 15 to about 30° C.) to air dry.

### The Untreated Syrup Composition

The untreated syrup composition contains from about 40% to about 52% solids, from about 10 g/I to 30 g/l of acetamide, at least about 40 g/l of sugars, a density of about 1 to about 2 g/cm³, and viscosity less than 500 SSU at 100° F. (38° C.). “SSU” is Saybolt Universal Viscosity in Seconds. The extent of evaporation may be modulated to achieve the desired solids content. When the pretreatment process used to prepare the biomass for saccharification is a process that uses ammonia, the untreated syrup contains at least about 5 g/l of ammonia. Untreated syrup can be further evaporated or partially dried to facilitate further manipulations. In one embodiment syrup is evaporated such that it contains from about 55% to about 60% solids.

### Pretreatment of Syrup

The untreated syrup contains undesirable components that can be modified or destroyed using at least one of chemical and enzymatic treatments, producing pretreated syrup. In one embodiment untreated syrup is treated with at least one of a chemical and an enzyme to reduce the amount of acetamide to less than 50% of the original level. In various embodiments the acetamide is reduced to less than 45%, 40%, 35%, 30%, 35%, 10%, 15%, 10%, 5%, or 1% of the original level. In various embodiments, chemicals useful for treatment of untreated syrup can be chemical oxidants, chemical reductants, chemical catalysts, organic chemicals, inorganic chemicals, bases, acids and mixtures thereof. For example, ozone or bleach can be used to remove odors, or modify the contained lignin in the untreated syrup. In one embodiment untreated syrup is treated with sulfuric acid or is treated with calcium oxide or sodium hydroxide and heat to reduce the concentration of acetamide in the resulting pretreated syrup. In embodiments, the pH of the syrup is lowered to less than pH 4 or less than pH 3 or less than pH 2.5. In embodiments, the pH is raised to greater than pH 10, greater than pH 11, or greater than pH 11.5. In embodiments, the syrup with altered pH is then heated to a temperature of at least about 90° C., at least about 95° C., or at least about 100° C. for a time sufficient to reduce the amount of acetamide.

Enzymatic treatment of untreated syrup can be performed by adding enzymes to untreated syrup to destroy or modify some of its undesirable components. An enzyme which reduces the amount of acetamide in a composition provided herein may be referred to as an acetamide treatment enzyme. Enzymes which may be employed for enzymatic treatment may include enzymes from a variety of sources, for example, enzymes from bacterial or fungal microorganisms. Enzymes which may be employed for enzymatic treatment may include amidases from bacterial or fungal microorganisms such as Pseudomonas, Emericella, Bacillus, Brevibacterium, Aspergillus, Saccharomyces, or Geomicrobium. Microbial amidases from Pseudomonas bacterium are available in the art and/or commercially. Examples include amidases from Pseudomonas aeruginosa (Sigma-Aldrich, St. Louis, Mo., #A6691; Andrade, et al, 2007, JBC, 282(27): 19598-19605; Shanker, et al., 1990, Arch. Microbiol. 154: 192-198). Amidase from Emericella nidulans (Mybiosource.com, San Diego, Calif., #MBS1150173) is also commercially available. Enzymes may include one or more other amidases known in the art such as those from Bacillus sterothermophilus BR388 (Cheong, et al., 2000, Enzyme and Microbial Technol., 26:152-158), Brevibacterium sp. strain R312 (Mayaux, et al., 1990, J. Bacteriol. p. 6764-6773), Bacillus sp. BR443 (Kim and Oriel, 2000, Enzyme and Microbial Technol. P. 492-501), Aspergillus nidulans (U.S. Pat. No. 6,548,285; Genbank Accession No. HM015509.1), Aspergillus oryzae (U.S. Pat. No. 6,548,285), Aspergillus niger (EP0758020), Saccharomyces cerevisiae (U.S. Pat. No. 6,548,285), or Geomicrobium sp. JCM 19037 (Genbank Accession No. GAK00267). An amidase which reduces the amount of acetamide in a composition provided herein may be referred to as an acetamidase. In embodiments, an acetamide treatment enzyme may be a urease. In some embodiments, the urease is not urease from Canavlia ensiformis (jack bean; Sigma-Aldrich, #U1500).

The pretreated syrup may comprise a reduced amount of acetamide as compared to the amount of acetamide in the untreated syrup and as such may be more suitable for application in the instant disclosure.

### Plant Growth Vehicle

A plant growth vehicle composition suitable for application in the instant disclosure comprises FC, lignocellulosic syrup, and at least one plant active material. The lignocellulosic syrup may be untreated or it may be pretreated. The plant growth vehicle can be used as a soil substitute to provide growth for various plant materials. Soil substitute, as used here, refers to any material that can provide mechanical and nutritional support for growth of the plant materials used in the instant disclosure.

FC, lignocellulosic syrup (either untreated or pretreated), and at least one plant active material can be contacted to provide the plant growth vehicle composition. Contacting of the FC, lignocellulosic syrup, and plant active material can be accomplished by any mixing method such as blending, stirring, shaking or using an agitator such as a Vortex® mixer or paddle mixer. FC, lignocellulosic syrup, and plant active material of the growth vehicle can exist in various concentrations. In various embodiments the FC is at least about 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, or 95 wt % of the plant growth vehicle, based on the total weight of the plant growth vehicle. In various embodiments the lignocellulosic syrup is at least about 1 wt %, 5 wt %, 10 wt %, 15 wt %, 20 wt %, 25 wt %, of the plant growth vehicle, based on the total weight of the plant growth vehicle. In various embodiments the plant growth material is at least about 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, or 75 wt % of the plant growth vehicle, based on the total weight of the plant growth vehicle. All weight percentages are based on the total weight of the composition. In general, a greater amount of lignocellulosic syrup may be included in the plant growth vehicle if the syrup is pretreated. Plant active materials are components that provide mechanical support, nutritional support, and/or other support for plant growth. Plant active materials included in the plant growth vehicle include at least one of microorganisms, soils, soil amending materials, and plant active additives.

### Microorganisms

Microorganisms that are beneficial to plant growth can be included in the present plant growth vehicle as a plant active material. In one embodiment microorganisms included can be any microorganisms that can degrade lignocellulosic biomass such as fungi and bacteria which can form humic and fulvic acid from lignocellulosic material. The microorganism expresses at least one lignocellulose degrading enzyme. Some examples of microorganisms particularly suited for lignocellulosic biomass degradation include, but are not limited to, various species of: Azotobacter, Novosphingobium, Pseudomonas, Rhodopseudomonas, Sphingomonas, Actinomycetes, Trichoderma, Aspergillus, Microtetraspora, Acinetobacter, Nocardia.

Further, a variety of recombinant bacteria or fungi, comprising genes of enzymes suitable for lignocellulose degradation, such as xylanase and cellulose, can be added to the composition suitable for the practice of the instant disclosure.

### Soils

For the practice of the instant disclosure, various types of soils can also be added to the growth vehicle as a plant active material. Soils suitable for this purpose can comprise any soil suitable for planting a variety of plants such as topsoil, and various types of potting soil.

Topsoil is usually placed over prepared subsoil prior to establishment of permanent vegetation. Topsoil is used to provide a suitable soil medium for vegetative growth. Unsuitable soils for vegetation can have low moisture content, low nutrient levels, low pH, materials toxic to plants, and/or unacceptable soil gradation.

Topsoil can be a loam, a sandy loam, a clay loam, a silt loam, a sandy clay loam or a loamy sand. Topsoil shall not be a mixture of contrasting textured subsoils, and shall contain less than 5% by volume of cinders, stones, slag, coarse fragments, gravel, sticks, roots, trash, or other materials larger than 4 centimeters in diameter.

A plant growth vehicle composition useful for instant disclosure can comprise soil. In various embodiments the plant growth vehicle composition may contain any amount of soil. The soil may be present in any amount between about 1 wt % and about 99 wt % of the plant growth vehicle. Weight percent are based on the total weight of the composition.

### Soil Amending Materials

One or more soil amending material (including soil conditioning material) can be included in the present plant growth vehicle as a plant active material. A soil amending material is a substance that when applied to soil, improves the properties of the soil such that plant growth and/or yield are increased. Soil properties that can be improved include, but are not limited to, pH, drainage, providing plant nutrients, soil structure, permeability, water infiltration, aeration, cation exchange capacity, and water retention. Any soil amending material that is mixable may be used in the present invention. Typically the soil amending material used is a material that is particulate, and is powdery, dusty, or granular. Some examples of soil amending materials include, but are not limited to, peat moss, wood chips, grass clippings, straw, compost, manure, biosolids, plant fibers, sawdust, wood ash, vermiculite, perlite, lime (also limestone), gypsum, clay, clay minerals, bone meal, tire chunks, pea gravel, and sand. Any of these materials may be processed to a mixable form for inclusion in the present plant growth vehicle. The soil amending materials can be used alone or in various combinations and mixtures. In one embodiment the soil amending material is the soil conditioner Turface®, which is calcined clay. In one embodiment the plant growth vehicle contains about 50 wt % FC, about 46 wt Turface®, and about 4 wt % untreated lignocellulosic syrup. In one embodiment the plant growth vehicle lacks the additives lime and gypsum.

In various embodiments the lignocellulosic syrup, FC, and soil amending material are contacted and combined in amounts wherein the syrup and the FC act as a binder of the soil amending material, which is typically crushed or powdered. In various embodiments the syrup is at least about 2 wt % of the total weight of the plant growth vehicle composition. In various embodiments the syrup is between about 2 wt % and about 20 wt % by weight of the final combination of lignocellulosic syrup, FC, optional soil, optional microorganisms, and soil amending material. The lignocellulosic syrup can be about 2 wt %, 3 wt %, 4 wt %, 5 wt %, 6 wt %, wt 7%, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt % of the total combined weight. In some embodiments the lignocellulosic syrup can be between about 2 wt % and about 20 wt %, or between about 2 wt % and about 10 wt %, of the final composition.

The combination of lignocellulosic syrup, FC and soil amending material is formed into a solid material that can be handled conveniently. Various shapes can be formed such as pellets, granules, irregular shapes, and the like. In one embodiment the lignocellulosic syrup can be sprayed over the FC and soil amending material in a rotating drum as it rotates. In one embodiment the lignocellulosic syrup and the FC can be sprayed over the soil amending material in a rotating drum as it rotates. In one embodiment the lignocellulosic syrup, FC and soil amending material composition can be dried. Alternative processing can include treatments such as heating, compressing, extruding, pelleting, molding, and/or drying.

### Other Plant Active Materials

Additional materials that can function as fertilizers can be added as plant active materials to the plant growth vehicle to help plant growth. Examples of fertilizing materials that can be used in the instant disclosure, include but are not limited to: vegetable waste and bio-degradable waste provided by natural bacteria, fungus and mechanical means and optionally mixed with cattle-dung, animal skin, poultry farm manure, pressed mud of sugar mills, sericulture waste, coconut fibers, bone powder and volcanic rock granulized by various bacterial cultures such as Azotobacter and Rhizobium, and combinations thereof. Further, crop active chemicals such as pesticides, fungicides, herbicides, and the like, can be added to the lignocellulosic syrup and FC singly or in any combination as additives.

The above-mentioned materials and any other additional chemicals suitable for including with the lignocellulosic syrup and the FC, to support growth of plant material, are called plant active materials.

The nature of one or more plant active materials to be included with the lignocellulosic syrup and the FC can be determined based on the needs of the plants, crops, or flowers at the time of application to the soil.

### Plant Nutrients

One or more plant nutrient may be a type of plant active material that is included in the present plant growth vehicle. Plant nutrients comprise macro- and micronutrients. As defined herein, primary macronutrients are nitrogen (N), phosphorous (P), and potassium (K). The macronutrients are important for plant growth and are used by plants in relatively large amounts in any combinations and proportions deemed suitable for each individual plant type, however, they are not always adequately available in natural soils to support the sustained growth of plants. Additionally, production of crops removes these vital macronutrients from the soil. Key macronutrients, such as nitrogen, which is essential to plant growth, will be readily removed from the soil by the production of crops.

Nitrogen for plants is provided primarily from urea, and to a lesser extent by the ammonium ion of the ammonium nitrate component. Nitrogen is vital for the formation of all new plant protoplasm. Chlorophyll is a nitrogen compound, and nitrogen is also heavily used by plants in forming stems and leaves. Blood, bone, or soybean meal or the dried residue of a manure or compost tea can also be used as substitute organic sources of nitrogen. Other nitrogen sources can include methylol urea, isobutylene urea or ammonia.

Phosphorus is provided largely by calcium phosphate and diammonium phosphate. Plants require phosphorus for photosynthesis, energy transfers within plants, and for good flower and fruit growth. Powdered bone meal, phosphate rock, and phosphoric acid can also be used as sources of phosphorus. Potassium is provided largely by muriate of potash, and to a much lesser extent by seaweed. Potassium is used by plants in the manufacture and movement of sugars and in cell division. It is necessary for root development and helps plants to retain water. Other possible sources of phosphorus would be wood ashes, granite dust, potassium chloride, potassium nitrate, potassium sulfate, and potassium carbonate.

Micronutrients (also known as trace elements) suitable for plant growth in the instant process include, but are not limited to; calcium, magnesium, iron, manganese, sulfur, molybdenum, iodine, silicon, zinc, copper, boron, and combinations thereof. These micronutrients can be added either together with macronutrients or separately to FC for supporting growth of the plant.

Any of the nutrients listed above, can be used alone or in combination with other nutrients and/or chemicals when preparing plant nutrients. The formulation and the ratio of the macro- and micronutrients in any given preparation are dictated by the specific plant's requirements.

### Sterilizing Agents

Sterilizing agents, suitable for the instant disclosure, are agents that can destroy microorganisms or inhibit their growth in an environment. Microorganisms include bacteria, fungi and viruses. Such agents can include, but are not limited to: heat, chemicals, irradiation, high pressure, and filtration as wells as various gases and chemicals. The FC and the lignocellulosic syrup of the disclosed plant growth vehicle can be sterilized to allow for their long term storage. Various chemicals can be used to sterilize FC and lignocellulosic syrup. Such materials include, but are not limited to: bleach, ozone, stabilized sodium chlorite (e.g., Fermasure®), chlorine, bromine, iodine, ethylene oxide, or any other agent known to destroy microorganisms.

### Application of the Plant Growth Vehicle

The plant growth vehicle disclosed herein can be applied using similar methods used for applying various plant enhancing materials as is known to those skilled in the relevant art. For example, the instant plant growth vehicle can be applied by spreading using a conventional fertilizer spreader of any size, such as for lawn care or for agricultural fields. Alternatively, it can be tilled into the soil prior to planting, applied after planting, and/or applied periodically during the growing season. Typically soil testing is performed prior to application to determine the specific type and amount of nutrient mixture to be applied to soil. In addition, the present plant growth vehicle may be used for growing plants in pots.

In some embodiments, a plant growth vehicle containing filter cake and lignocellulosic syrup, and optionally including a plant active material, can be applied as described above. The lignocellulosic syrup can be either untreated syrup or pretreated syrup. In some embodiments the soil to which the filter cake and lignocellulosic syrup is applied provides a plant active material. In some embodiments, fertilizer, weed controlling chemicals and other plant active materials are applied separately from the filter cake and lignocellulosic syrup.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### ABBREVIATIONS

The meaning of abbreviations used is as follows: “s” is second, “min” means minute(s), “h” or “hr” means hour(s), “μL” or “μl” means microliter(s), “mL” or “ml” means milliliter(s), “L” or “l” means liter(s), “m” is meter, “nm” means nanometer(s), “mm” means millimeter(s), “cm” means centimeter(s), “μm” means micrometer(s), “mM” means millimolar, “M” means molar, “mmol” means millimole(s), “μmole” means micromole(s), “g” means gram(s), “μg” means microgram(s), “mg” means milligram(s), “kg” is kilogram, “rpm” means revolutions per minute, “C” is Centigrade, “ppm” means parts per million, “cP” is centipoise, “g/l” means grams per liter, “SSU” is Saybolt Universal Viscosity in Seconds, “μE/m²” is microeinsteins per square meter.

### Suppliers

The growth chamber was a Conviron® model BDW-120, obtained from Conviron® (590 Berry Street, Winnipeg, Manitoba, Canada R3H 0R9.

Metro-Mix®, was obtained from Sun Gro® Horticulture. 770 Silver Street, Agawam, Mass., U.S.A. Metro-Mix® 360 was used in the Examples.

Turface® was obtained from Athletics, 750 Lake Cook Rd, Suite 440, Buffalo Grove, Ill. U.S.A. Turface® MVP® (calcined clay) was used in the Example below.

### Analytical Method

Samples were analyzed for acetamide concentration by gas chromatography on an Agilent Technologies HP 6890 Gas Chromatograph system equipped with an auto-sampler and a flame ionization detector. The gas chomatographic column used was an Agilent Technologies J&W DB-FFAP (30 m×250 μm ID×0.25 μm nominal thickness column). Sulfolane was used as an external reference. One microliter of sample was injected with a split ratio of 75.0:1 and a flow of 102 mL/min of helium at an injection port temperature of 225° C. The oven containing the column was heated from 80° C. to 250° C. at a rate of 15° C./min and then held at 250° C. for 3 min. The flame ionization detecter was set at 250° C. with a hydrogen flow of 35 mL/min and an air flow of 350 mL/min.

### Example 1

### Growth of Soybean Seeds Using Lignocellulosic Syrup and FC

This example was performed to examine possible phytotoxicity of the lignocellulosic syrup and FC to seeds. Soybean seeds (seed variety label 93M11) were germinated in a growth chamber maintained at 31° C. during the day, at 22° C. at night, with 60% relative humidity (relative humidity is based on ratio of the partial pressure of water vapor to the equilibrium vapor pressure of water at the same temperature), and with a 13 h photoperiod (220 ρE/m²)).

Three separate soils were used as growth media:

Sample 1) The soil in this sample contained Metro-Mix® potting soil. It had a high organic content. It was sterilized, however some fungal activity was present in this soil.

Sample 2) The soil in this sample contained 50:50 LB2/Turface®. LB2 is a mixture of sphagnum peat moss, coarse perlite, gypsum, and dolomitic limestone (formulated potting soil mixture)

Sample 3) The third sample contained FC (which was autoclaved and ground to break up larger pieces, making a more uniform material, before use) 50 wt %, Turface® 46 wt %, lignocellulosic syrup (52% solids) 4 wt %. The FC was sterilized in an autoclave for 30 min dry cycle, with a maximum temperature of 133° C. The autoclave was an Amsco® Century® Scientific SG-120 Eagle/Century Series purchased from Steris Co. 5960 Heisley Road, Mentor, Ohio, USA. Ten soybean seeds were planted in each growth medium, and germination and growth were monitored daily. Water was provided on an “as needed basis”, which was usually every 2 to 3 days.

The sample with Metro-Mix® showed 50% germination as evidenced by the number of germinated seeds. The sample with LB2/Turface® showed 100% germination as evidenced by the number of germinated seeds. The sample with FC, lignocellulosic syrup and Turface® showed 80% germination as evidenced by the number of germinated seeds. Assessment of soybean seedling vigor and health is given in Table 1. Assessment was by visual inspection using a relative scale of 1 to 10.

TABLE 1
Ratings of soybean seedlings at 6 days after planting

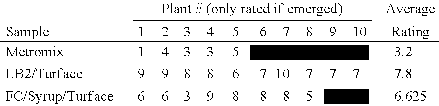

A blackened box indicates no germination

### Example 2

### Chemical Treatment of Syrup (Sulfuric Acid)

Lignocellulosic syrup (1.0179 g) which had a concentration of acetamide of 1.83 weight percent was mixed with 4.9545 g of deionized water in a 20 mL vial equipped with a Teflon®-coated magnetic stirring bar to produce a diluted lignocellulosic syrup with a concentration of acetamide of 0.339 weight percent. Concentrated sulfuric acid (98%, 0.0770 g) was added to lower the pH of the solution to 2.05. The vial was sealed and heated at 100° C. for 22 h with stirring. After analysis, it was determined that the diluted lignocellulosic syrup contained 0.039 weight percent of acetamide.

### Example 3

### Treatment of Syrup at High pH (Calcium Oxide)

Lignocellulosic syrup (1.0220 g) which had a concentration of acetamide of 1.83 weight percent was mixed with 4.9527 g of deionized water in a 20 mL vial equipped with a Teflon®-coated magnetic stirring bar to produce a diluted lignocellulosic syrup with a concentration of acetamide of 0.378 weight percent. Calcium oxide (0.1329 g) was added to raise the pH of the solution to 11.97. The vial was heated at 100° C. and stirred for 22 h. It was determined that the diluted lignocellulosic syrup contained 0.121 weight percent acetamide.

### Example 4

### Treatment of Syrup at High pH (Sodium Hydroxide)

Lignocellulosic syrup (1.0214 g) which had a concentration of acetamide of 1.83 weight percent was mixed with 4.9497 g of deionized water in a 20 mL vial equipped with a Teflon®-coated magnetic stirring bar to produce a diluted lignocellulosic syrup with a concentration of acetamide of 0.378 weight percent. Sodium hydroxide (0.1094 g) was added to raise the pH of the solution to 11.95. The vial was heated at 100° C. and stirred for 22 h. It was determined that the diluted lignocellulosic syrup contained 0.178 weight percent acetamide.

### Example 5

### Enzymatic Treatment of Syrup with Jack Bean Urease

Lignocellulosic syrup (2.4026 g, 2.3895 g, 2.3513 g, 2.3175 g) which had a concentration of acetamide of 1.83 weight percent was added to four separate 4 mL vials each equipped with a Teflon®-coated magnetic stirring bar. Approximately the same amount of Urease (obtained from Sigma-Aldrich Co., St. Louis, Mo., Catalog Number U1500, Type III, powder, 15,000-50,000 units/g solid) was added to each vial (2.4 mg, 2.6 mg, 3.0 mg, respectively). No urease was added to the fourth vial (control). The vials were stirred at room temperature. After 2 h, 7 h, and 24 h, each of the vials was removed from the magnetic stirrer, and sampled. At the end of each time period, all of the vials had a concentration of acetamide of 1.83 weight percent.

1. A plant growth vehicle composition comprising:
a) lignocellulosic filter cake;
b) lignocellulosic syrup; and
c) a plant active material;
wherein the composition supports plant growth.

2. The composition of claim 1 wherein the lignocellulosic filter cake and the lignocellulosic syrup are co-products of a lignocellulosic biomass fermentation process.

3. The composition of claim 1, wherein the lignocellulosic syrup is pretreated syrup.

4. The composition of claim 1, wherein the plant active material is selected from the group consisting of a soil, a soil amending material, a microorganism, and a plant active additive.

5. The composition of claim 3, wherein the pretreated lignocellulosic syrup has been treated with at least one chemical or at least one enzyme to reduce the amount of acetamide as compared to the amount of acetamide in untreated lignocellulosic syrup.

6. The composition of claim 4 wherein the microorganism expresses at least one lignocellulose degrading enzyme.

7. The composition of claim 4, wherein the plant active additive is selected from the group consisting of at least one plant nutrient, at least one fertilizing material, at least one crop active chemical, and any combination thereof.

8. The composition of claim 4, wherein the soil amending material is selected from the group consisting of vermiculite, clay minerals, peat moss, gypsum, perlite, lime, plant fibers, calcined clay, and mixtures thereof.

9. The composition of claim 1 wherein the syrup of (b) is at least about 2 wt % of the total plant nutrient vehicle weight.

10. A method for providing a growth vehicle for plant material, comprising:
a) providing lignocellulosic filter cake;
b) providing lignocellulosic syrup;
c) contacting the filter cake and the lignocellulosic syrup to form a plant growth vehicle;
d) providing the plant material; and
e) contacting the plant material with the growth vehicle of (c);
wherein the growth vehicle allows the plant material to grow.

11. The method of claim 10 wherein the lignocellulosic filter cake and the lignocellulosic syrup are co-products of a lignocellulosic biomass fermentation process.

12. The method of claim 10 wherein the lignocellulosic syrup is pretreated syrup.

13. The method of claim 12, wherein the pretreated lignocellulosic syrup has been treated with either at least one chemical or at least one enzyme to reduce the amount of acetamide as compared to the amount of acetamide in untreated lignocellulosic syrup.

14. The method of claim 10, further comprising contacting in (c) with one or more plant active materials selected from the group consisting of a plant active additive, a soil, a soil amending material, and a microorganism.

15. The method of claim 14, wherein the microorganism expresses at least one lignocellulosic degrading enzyme.

16. The method of claim 14 wherein the plant active additive is selected from the group consisting of at least one plant nutrient, at least one fertilizing material, at least one crop active chemical, and combinations thereof.

17. The method of claim 14, wherein the soil amending material is selected from the group consisting of vermiculite, clay minerals, peat moss, gypsum, perlite, lime, plant fibers, calcined clay, and mixtures thereof.

18. The method of claim 12, wherein the pretreated lignocellulosic syrup has a reduced amount of acetamide as compared to the amount of acetamide in untreated lignocellulosic syrup.

19. The method of claim 10, wherein the lignocellulosic syrup and the lignocellulosic filter cake are treated with at least one sterilizing agent.
